(19) United States
(12) Patent Application Publication
(10) Pub. No.: US 2026/0326704 A1
(43) Pub. Date: Oct. 22, 2026

(54) GAS-GENERATING AGENT COMPOSITION

(71) Applicant: DAICEL CORPORATION, Osaka-shi, Osaka (JP)

(72) Inventors: Youji FUJISAKI, Tokyo (JP); Emiko FUJIWARA, Tokyo (JP); Shota KATAYAMA, Tokyo (JP)

(73) Assignee: DAICEL CORPORATION, Osaka-shi, Osaka (JP)

(21) Appl. No.: 19/109,508

(22) PCT Filed: Sep. 7, 2023
(86) PCT No.: PCT/JP2023/032701

§ 371 Date: Mar. 6, 2025

(30) Foreign Application Priority Data
Sep. 7, 2022 (JP) 2022-142435

(51) Int. Cl. B60R 21/264; C06B 21/00; C06B 33/04; C06D 5/06

(52) U.S. Cl. CPC B60R 21/2644; C06B 21/0033; C06B 33/04; C06D 5/06

(57) ABSTRACT

A gas-generating agent composition containing guanidine nitrate, basic copper nitrate, potassium perchlorate a content of which is 12 parts by weight or more per a total content of 100 parts by weight of the guanidine nitrate, the basic copper nitrate, and the potassium perchlorate, and an amorphous oxide.

### TECHNICAL FIELD

The present disclosure relates to a gas-generating agent composition.

### BACKGROUND ART

Vehicle safety devices, such as an airbag device, installed in a vehicle, employ inflators that use a gas-generating agent composition, and attempts have been made to ensure the product reliability of such inflators. While gas-generating agent compositions are being widely developed, attention is being focused on guanidine nitrate and basic copper nitrate type gas-generating agent compositions, which use guanidine nitrate as a fuel component and basic copper nitrate as an oxidant, from the viewpoints of minimizing the generation of toxic gases and exhibiting an excellent combustion rate.

For example, Patent Document 1 discloses a technique for providing, as a guanidine nitrate and basic copper nitrate type gas-generating agent composition, a gas-generating agent composition that exhibits an excellent combustion rate by blending a specific reducing agent and oxidant and subjecting the mixture to a specific roller compacting treatment in the production stage.

Moreover, Patent Document 2 discloses a technique for providing, as a guanidine nitrate and basic copper nitrate type gas-generating agent composition, a gas-generating agent composition that contains potassium perchlorate, and in which the content of guanidine nitrate, the content of basic copper nitrate, and the content of potassium perchlorate are each within a specific range, thereby improving combustion characteristics and heat resistance.

### CITATION LIST

### Patent Document

Patent Document 1: JP 2009-511411 T
Patent Document 2: JP 2018-154539 A

### SUMMARY OF INVENTION

### Technical Problem

Typically, guanidine nitrate and basic copper nitrate type gas-generating agent compositions have been studied with attention focused on the combustion rate, and potassium perchlorate has been added in expectation of further improvements in the combustion rate.

The present inventors conducted further studies in a system in which potassium perchlorate is added to a guanidine nitrate and basic copper nitrate type gas-generating agent composition, and discovered that the ignition time is shortened as the blending proportion of the potassium perchlorate is increased. On the other hand, the present inventors also discovered that in a low-pressure environment, when the blending proportion of potassium perchlorate becomes a certain level or greater, combustion becomes unstable and may be interrupted. In a case where a gas-generating agent composition whose combustion is interrupted in a low-pressure environment is used in an inflator or the like, there is a risk of causing the combustion of the gas-generating agent composition to be extinguished when the internal pressure of the inflator is low, such as at the initial stage or the final stage of inflator operation. In such a case, the amount of gas for inflating the airbag may be insufficient, and thus the necessary requirement for restraining the passenger may be unsatisfied.

Therefore, an object of the present disclosure is to provide a gas-generating agent composition that has a short ignition time and for which an interruption of combustion in a low-pressure environment does not easily occur.

### Solution to Problem

As a result of intensive studies, the present inventors discovered that the above issues can be solved by blending a specific amount or more of potassium perchlorate into a guanidine nitrate and basic copper nitrate type gas-generating agent composition and further adding an amorphous oxide, and thereby the present inventors arrived at the present disclosure.

[1] A gas-generating agent composition containing:
guanidine nitrate;
basic copper nitrate; and
potassium perchlorate,
wherein
in the gas-generating agent composition, the content of the potassium perchlorate is 12 parts by weight or more relative to 100 parts by weight of the total content of the guanidine nitrate, the basic copper nitrate, and the potassium perchlorate, and
the gas-generating agent composition further contains an amorphous oxide.

[2] The gas-generating agent composition according to [1], wherein the amorphous oxide is one or more selected from the group consisting of silica gel, silicate glass, borosilicate glass, borate glass, aluminosilicate glass, aluminophosphate glass, and aluminoborosilicate glass.

[3] The gas-generating agent composition according to [2], wherein the silica gel has an average specific surface area of 300 m²/g or greater.

[4] The gas-generating agent composition according to any one of [1] to [3], wherein the total content of the amorphous oxide in the gas-generating agent composition is from 0.1 wt. % to 10 wt. %.

[5] The gas-generating agent composition according to any one of [1] to [4], wherein the amorphous oxide has an average aspect ratio of 8 or less.

[6] The gas-generating agent composition according to any one of [1] to [5], wherein the amorphous oxide has an average particle size of from 1 μm to 100 μm.

[7] The gas-generating agent composition according to any one of [1] to [6], containing no binder.

[8] The gas-generating agent composition according to [7], wherein a content of the guanidine nitrate is from 30 mass % to 70 mass %.

[9] The gas-generating agent composition according to any one of [1] to [8], wherein an oxygen balance is from −0.05 g/g to 0.05 g/g, the oxygen balance being calculated on the basis of:
(A) guanidine nitrate, nitroguanidine, melamine, melamine cyanurate, 5-aminotetrazole, 5,5′-bitetrazole diammonium salt, guanylurea dinitramide, dicyanodicarbonamide, cyanuric acid, tartaric acid, Na tartrate, succinic acid, 3-nitro-1,2,4-triazol-5-one, 2-nitroimino-5-nitrohexahydro-1,3,5-triazine, and carbonaceous materials;
(B) basic copper nitrate, strontium nitrate, basic copper carbonate, 5-AT-BCN complex, copper oxide, potassium perchlorate, potassium chlorate, potassium nitrate, sodium nitrate, ammonium nitrate, ammonium perchlorate, sodium perchlorate, copper(II) oxide, copper(I) oxide, phase-stabilized ammonium nitrate (AN/KN=90/10), and phase-stabilized ammonium nitrate (AN/KN=85/15);
(C) sodium carboxymethyl cellulose, guar gum, polyacrylamide, hydroxyethyl cellulose, hydroxypropyl methyl cellulose, polyvinyl alcohol, ethyl cellulose, polyvinyl pyrrolidone, starch, and silicone; and
(D) calcium stearate and magnesium stearate.

[10] The gas-generating agent composition according to any one of [1] to [9], further containing aluminum hydroxide.

[11] A gas-generating agent molded article formed by molding the gas-generating agent composition described in any one of [1] to [10] into a pellet shape, a single-hole cylindrical shape, or a multi-hole cylindrical shape.

[12] A side airbag inflator containing:
the gas-generating agent composition described in any one of [1] to [10].

[13] A side airbag inflator containing:
the gas-generating agent molded article described in [11].

### Advantageous Effects of Invention

According to the present disclosure, a gas-generating agent composition that has a short ignition time and for which an interruption of combustion in a low-pressure environment does not easily occur can be provided.

### DESCRIPTION OF EMBODIMENTS

Hereinafter, embodiments of the present disclosure will be described in detail, but each configuration, a combination of configurations, and the like in each embodiment are an example, and an addition, an omission, a substitution, and another change can appropriately be made without departing from the spirit of the present disclosure. The present disclosure is not limited by the embodiments and is limited only by the claims.

In the present disclosure, a numerical range expressed by “to” implies a range including the numerical values described before and after “to” as the lower limit value and the upper limit value. Specifically, “A to B” implies a value that is A or more and B or less.

Still more, the expression “A or B” in the present disclosure can be read as “at least one selected from the group consisting of A and B”.

Yet more, in the present disclosure, “a plurality of” means “two or more”.

### Gas-Generating Agent Composition

A gas-generating agent composition according to an embodiment of the present disclosure (also simply referred to as a “gas-generating agent composition”) is a gas-generating agent composition containing guanidine nitrate, basic copper nitrate, and potassium perchlorate, wherein
in the gas-generating agent composition, the content of the potassium perchlorate is 12 parts by weight or more relative to 100 parts by weight of the total content of the guanidine nitrate, the basic copper nitrate, and the potassium perchlorate, and
the gas-generating agent composition further contains an amorphous oxide.

The present inventors discovered that in a system in which potassium perchlorate is added to a known guanidine nitrate and basic copper nitrate type gas-generating agent composition, the time required for ignition is shortened by increasing the blending proportion of the potassium perchlorate. On the other hand, in a low-pressure environment, when the blending proportion of potassium perchlorate is a certain level or higher, combustion becomes unstable and is interrupted, unfortunately.

Hence, the present inventors made intensive studies, and thereby discovered that a gas-generating agent composition for which an interruption of combustion in a low-pressure environment hardly occurs even when the blending proportion of potassium perchlorate is high can be produced by blending an amorphous oxide. In a low-pressure environment, typically a residue of the combusted portion is easily dispersed, and the transfer of heat to the non-combusted portion is delayed, resulting in an interruption of combustion. However, the present inventors speculated that the reason why an interruption of combustion in a low-pressure environment does not easily occur with the gas-generating agent composition of the present disclosure is that because the composition contains amorphous oxide, the residue is not easily dispersed, and heat transfer is facilitated.

Note that in the present disclosure, the low-pressure environment means an environment of 1 MPa or less.

### Guanidine Nitrate

The gas-generating agent composition contains guanidine nitrate as a combustion component. As the guanidine nitrate, one produced by a known method may be used, or a commercially available product may be used.

The content of guanidine nitrate in the gas-generating agent composition is not particularly limited, but is preferably from 30 wt. % to 70 wt. %, and more preferably from 40 wt. % to 60 wt. %, and in particular, when the composition is produced by a wet method (when the composition contains a binder), the content thereof is even more preferably from 40 wt. % to 50 wt. %, and when the composition is produced by a dry method (when the composition contains no binder), the content of guanidine nitrate is even more preferably from 50 wt. % to 60 wt. %.

When the content of guanidine nitrate is equal to or less than the upper limit of the above range, the generation of a large amount of harmful carbon monoxide due to a shortage of the oxidant component can be prevented, and the load-bearing strength can be improved. When the content is equal to or greater than the lower limit of the abovementioned range, the amount of generated gas is reduced, and an increase in nitrogen oxides due to excess oxygen is prevented.

In particular, in a case in which the composition is produced by a dry method (when the composition does not contain a binder), when the content of guanidine nitrate in the composition is less than 30 mass %, it becomes difficult to mold the composition, and if the content thereof exceeds 70 mass %, the composition can be molded but has insufficient strength.

### Basic Copper Nitrate

The gas-generating agent composition contains basic copper nitrate as a first oxidant. As the basic copper nitrate, one produced by a known method may be used, or a commercially available product may be used.

The content of the basic copper nitrate in the gas-generating agent composition is not particularly limited, but is usually from 10 wt. % to 60 wt. %, preferably from 10 wt. % to 50 wt. %, more preferably from 10 wt. % to 40 wt. %, and still more preferably from 15 wt. % to 40 wt. %.

When the content of the basic copper nitrate is equal to or less than the upper limit of the abovementioned range, the amount of generated gas decreases, making it easier to prevent an increase in nitrogen oxide due to excess oxygen. When the content thereof is equal to or greater than the lower limit of the abovementioned range, the combustion temperature can be lowered while maintaining the oxygen balance.

### Potassium Perchlorate

The gas-generating agent composition contains potassium perchlorate as a second oxidant. As the potassium perchlorate, one produced by a known method may be used, or a commercially available product may be used.

The content of the potassium perchlorate is not particularly limited as long as the content thereof is 12 parts by weight or more per 100 parts by weight of the total content of the guanidine nitrate, the basic copper nitrate, and the potassium perchlorate in the gas-generating agent composition, but the content of the potassium perchlorate is preferably from 12 parts by weight to 35 parts by weight, more preferably from 12.5 parts by weight to 30 parts by weight, and still more preferably from 12 parts by weight to 25 parts by weight.

When the above content is equal to or less than the upper limit of the above-described range, a phenomenon such as damage to the airbag due to an excessively high combustion temperature can be easily prevented. When the content thereof is equal to or greater than the lower limit of the above-described range, the ignition time of the gas-generating agent composition can be improved.

The total content of the guanidine nitrate, the basic copper nitrate, and the potassium perchlorate in the gas-generating agent composition is not particularly limited, but is usually 85 wt. % or greater and less than 100 wt. %, preferably from 90 wt. % to 99.9 wt. %, more preferably from 90 wt. % to 99.5 wt. %, and even more preferably from 93 wt. % to 99.5 wt. %.

When the content thereof is equal to or less than the upper limit of the above-described range, the effect of the amorphous oxide can be exhibited. When the content thereof is equal to or greater than the lower limit of the above-described range, the ignition time of the gas-generating agent composition can be improved.

In the gas-generating agent composition, the ratio of the content (weight) of the potassium perchlorate times 100 to the content (weight) of the guanidine nitrate (potassium perchlorate content (weight)×100/guanidine nitrate content (weight)) is not particularly limited, but is usually from 10 to 70, preferably from 10 to 60, more preferably from 10 to 55, still more preferably from 15 to 55, and particularly preferably from 18 to 50.

An excessive increase in the amount of the particulate residue that cannot be captured even by the components of the inflator can be prevented by setting the above ratio to equal to or less than the upper limit of the above range. Moreover, the ignition time of the gas-generating agent composition can be improved by setting the ratio thereof to equal to or greater than the lower limit of the above range.

The oxygen balance calculated on the basis of the below-described components (A) and (B) in the gas-generating agent composition is not particularly limited, but is usually from −0.05 g/g to 0.05 g/g, preferably from −0.05 g/g to 0.04 g/g, more preferably from −0.05 g/g to 0.04 g/g, still more preferably from −0.04 g/g to 0.03 g/g, and particularly preferably from −0.03 g/g to 0.03 g/g. The oxygen balance is an excess or shortage of oxygen required to completely oxidize the gas-generating agent composition. The oxygen balance is a positive value when there is an excess of oxygen, and is a negative value when there is a shortage of oxygen.

For this oxygen balance, conditions are preferably satisfied as a parameter calculated on the basis of the below-described components (A) to (D), but may be satisfied as a parameter of the oxygen balance of the gas-generating composition (the entire gas-generating composition).

An increase in nitrogen oxides due to excess oxygen can be easily prevented by setting the oxygen balance to be equal to or less than the upper limit of the above range. In addition, an increase in carbon monoxide due to oxygen deficiency can be easily prevented by setting the oxygen balance to be equal to or greater than the lower limit of the above range.

The condition of the oxygen balance range described above is preferably satisfied as an oxygen balance that is calculated on the basis of the following components (A) to (D). The components listed below do not represent components that are essential to the composition, but rather, are components that are subject to calculation of the oxygen balance if included. The component (A) is a component corresponding to a fuel, the component (B) is a component corresponding to an oxidant, the component (C) is a component corresponding to a binder, and the component (D) is a component corresponding to a lubricant. In addition to these components, the gas-generating composition may contain other components that affect the oxygen balance.
(A) Guanidine nitrate, nitroguanidine, melamine, melamine cyanurate, 5-aminotetrazole, 5,5′-bitetrazole diammonium salt, guanylurea dinitramide, dicyanodicarbonamide, cyanuric acid, tartaric acid, Na tartrate, succinic acid, 3-nitro-1,2,4-triazol-5-one, 2-nitroimino-5-nitrohexahydro-1,3,5-triazine, and carbonaceous materials (for example, activated carbon)
(B) Basic copper nitrate, strontium nitrate, basic copper carbonate, 5-AT-BCN complex, copper oxide, potassium perchlorate, potassium chlorate, potassium nitrate, sodium nitrate, ammonium nitrate, ammonium perchlorate, sodium perchlorate, copper(II) oxide, copper(I) oxide, phase-stabilized ammonium nitrate (AN/KN=90/10), and phase-stabilized ammonium nitrate (AN/KN=85/15)
(C) Sodium carboxymethyl cellulose, guar gum, polyacrylamide, hydroxyethyl cellulose, hydroxypropyl methyl cellulose, polyvinyl alcohol, ethyl cellulose, polyvinyl pyrrolidone, starch, and silicone
(D) Calcium stearate and magnesium stearate

In the present disclosure, an expression such as “phase-stabilized ammonium nitrate (AN/KN=90/10)” means “ammonium nitrate (AN) phase-stabilized with potassium nitrate (KN) (in terms of the weight ratio, AN/KN=90/10)”.

Specific examples of the carbonaceous material in the component (A) include activated carbon, coal, refined coal, carbon black, carbon products, solid crude oil, coal tar pitch, carbon fibers, tar, carbon, coke, graphite, and the like.

Hereinafter, a method for calculating the oxygen balance will be described.

For example, guanidine nitrate is oxidized by the following reaction.

CH₆N₄O₃+O₂→2N₂+CO₂+3H₂O

Accordingly, from the following equation (1), the oxygen balance related to the guanidine nitrate is −0.262 g/g. When the oxygen balances of the basic copper nitrate and potassium perchlorate are similarly calculated from the oxidation reaction, the oxygen balance with regard to the basic copper nitrate is 0.300 g/g, and the oxygen balance with regard to the potassium perchlorate is 0.462 g/g.

$$[ Math . 1 ]$$

$$OXYGEN BALANCE = \frac{A MOUNT OF OXYGEN EXCESS OR SHORTAGE}{M O L E CULAR WEIGHT OF MATERIAL} \qquad ( 1 )$$

Therefore, for example, when the gas-generating agent composition contains only guanidine nitrate, basic copper nitrate, and potassium perchlorate as the components (A) to (D), the oxygen balance calculated from the components (A) to (C) is represented by the following equation, where a represents the content (wt. %) of guanidine nitrate, b represents the content (wt. %) of the basic copper nitrate, and c represents the content (wt. %) of the potassium perchlorate.

Oxygen balance (g/g) of gas-generating agent composition={a×(−0.262)+b×0.300+c×0.462}/100

The numerical range of the above-described oxygen balance is preferably satisfied as a parameter calculated on the basis of the components (A) to (D), but may be satisfied as a parameter of the oxygen balance of the gas-generating composition (the gas-generating composition as a whole). When considered as the oxygen balance of the gas-generating composition (gas-generating composition as a whole), the oxygen balance can be calculated from the respective oxygen balances of all components contributing to the oxygen balance in the composition.

The oxygen balance of each of the components (A) to (D) is shown in Table 1 below. In Table 1, Al(OH)₃ and basic magnesium carbonate are listed as components (E), which are substances that may be added, but these substances do not contribute to the oxygen balance (that is, the oxygen balance thereof is 0 g/g).

TABLE 1

| | | Oxygen |
|---|---|---|
| | | Balance |
| | | (g/g) |
| Component | | |
| A | Guanidine nitrate | −0.262 |
| | Nitroguanidine | −0.307 |
| | Melamine | −1.142 |
| | Melamine cyanurate | −0.847 |
| | 5-Aminotetrazole | −0.658 |
| | 5,5'-Bitetrazole diammonium salt | −0.744 |
| | Guanylurea dinitramide | −0.191 |
| | Dicyanodicarbonamide | −1.142 |
| | Cyanuric acid | −0.558 |
| | Tartaric acid | −0.533 |
| | Na tartrate | −0.348 |
| | Succinic acid | −0.949 |
| | 3-Nitro-1,2,4-triazol-5-one | −0.246 |
| | 2-Nitroimino-5-nitro- | −0.635 |
| | hexahydro-1,3,5-triazine | |
| | Carbonaceous material | −2.664 |
| | Basic copper nitrate | 0.300 |
| | Strontium nitrate | 0.378 |
| B | Basic copper carbonate | 0.145 |
| | 5-AT-BCN complex | 0.052 |
| | Copper oxide | 0.201 |
| | Potassium perchlorate | 0.462 |
| | Potassium chlorate | 0.392 |
| | Potassium nitrate | 0.396 |
| | Sodium nitrate | 0.471 |
| | Ammonium nitrate | 0.200 |
| | Ammonium perchlorate | 0.340 |
| | Sodium perchlorate | 0.523 |
| | Copper(II) oxide | 0.201 |
| | Copper(I) oxide | 0.112 |
| | Phase-stabilized ammonium nitrate | 0.220 |
| | (AN/KN = 90/10) | |
| | Phase-stabilized ammonium nitrate | 0.229 |
| | (AN/KN = 85/15) | |
| Composition | | |
| C | Sodium carboxymethyl cellulose | −1.004 |
| | Guar gum | −1.143 |
| | Polyacrylamide | −1.688 |
| | Hydroxyethyl cellulose | −1.368 |
| | Hydroxypropyl methyl cellulose | −1.474 |
| | Polyvinyl alcohol | −1.818 |
| | Ethyl cellulose | −1.761 |
| | Polyvinyl pyrrolidone | −1.725 |
| | Starch | −1.185 |
| | Silicone | −1.726 |
| D | Calcium stearate | −2.741 |
| | Magnesium stearate | −2.814 |
| E | Al(OH)₃ | 0 |
| | Basic magnesium carbonate | 0 |

### Amorphous Oxide

The gas-generating agent composition further contains an amorphous oxide in addition to the above components. By blending the amorphous oxide in the gas-generating agent composition, a sufficient combustion amount of the gas-generating agent composition can be secured while ensuring a short ignition time.

The type of amorphous oxide is not particularly limited, and examples include one or more substances selected from the group consisting of silica gel, silicate glass, borosilicate glass, borate glass, aluminosilicate glass, aluminophosphate glass, and aluminoborosilicate glass. The amorphous oxide is preferably one or more substances selected from the group consisting of silica gel, aluminophosphate glass, and aluminoborosilicate glass, and more preferably one or more substances selected from the group consisting of silica gel and aluminoborosilicate glass, and from the viewpoint of a short combustion time in a low-pressure environment, the amorphous oxide is even more preferably silica gel. Note that the oxygen balance of the amorphous oxides specifically listed here is 0 g/g.

As the abovementioned amorphous oxide, one produced by a known method may be used, or a commercially available product may be used.

The total content of the amorphous oxide in the gas-generating agent composition is not particularly limited, but is preferably from 0.1 wt. % to 10 wt. %, more preferably from 0.5 wt. % to 10 wt. %, still more preferably from 0.5 wt. % to 5 wt. %, and particularly preferably from 0.5 wt. % to 3 wt. %.

An increase in the time until the gas-generating agent composition is ignited can be prevented by setting the abovementioned content to be equal to or less than the upper limit of the above range. Moreover, the phenomenon of interruption of combustion in a low-pressure environment can be improved by setting the content thereof to equal to or greater than the lower limit of the above range.

The shape of the amorphous oxide is not particularly limited, and may be, for example, a particle shape or a non-fiber shape, and from the viewpoint of the density of the gas-generating agent composition, the shape of the amorphous oxide is preferably a particle shape. In the present disclosure, particle shape means that the average aspect ratio is 8 or less.

The average aspect ratio of the amorphous oxide is not particularly limited, but is usually 8 or less, preferably 7.5 or less, and more preferably 7 or less. The lower limit thereof is not particularly limited, but may be 1 or greater.

When the average aspect ratio is equal to or less than the upper limit of the above range, the density of the gas-generating agent composition can be improved, which contributes to a weight reduction of the inflator.

The average aspect ratio of the amorphous oxide can be calculated as follows. (1) In a case in which the amorphous oxide can be collected from the gas-generating agent composition, a plurality of amorphous oxides (at least ten amorphous oxide particles) are collected, each amorphous oxide is observed using a scanning electron microscope (SEM), a ratio of the major axis to the minor axis (major axis/minor axis) of each amorphous oxide is determined, and the average aspect ratio is calculated as an average value of the determined ratios. Otherwise, (2) in a case in which the amorphous oxide cannot be collected from the gas-generating agent composition, a cross-section of the gas-generating agent composition is observed using a scanning electron microscope (SEM), the ratio of the major axis to the minor axis (major axis/minor axis) of each amorphous oxide observed on the cross section is determined, and the average aspect ratio is calculated as the average value of the determined ratios.

When the amorphous oxide is in the form of particles, the average particle size thereof is not particularly limited, but is usually from 0.1 μm to 100 μm, preferably from 0.5 μm to 100 μm, more preferably from 1 μm to 100 μm, still more preferably from 2 μm to 90 μm, and particularly preferably from 2 μm to 80 μm.

When the above average particle size is within the above range, the effect of improvement against combustion interruption in a low-pressure environment can be exhibited.

The average particle size of the amorphous oxide can be calculated as follows. (1) In a case in which the amorphous oxide can be collected from the gas-generating agent composition, a plurality of amorphous oxides (at least ten amorphous oxides) are collected, each amorphous oxide is observed using a scanning electron microscope (SEM), the particle size of each amorphous oxide is determined, and the average particle size is calculated as an average value of the determined particle sizes. Otherwise, (2) in a case in which the amorphous oxide cannot be collected from the gas-generating agent composition, a cross-section of the gas-generating agent composition is observed using a scanning electron microscope (SEM), the particle size of each amorphous oxide observed on the cross section is determined, and the average particle size is calculated as the average value of the determined particle sizes.

In a case in which a silica gel, which is a porous material, is used as the amorphous oxide, the average specific surface area is not particularly limited, but is preferably 250 m²/g or greater, and more preferably 300 m²/g or greater, and is preferably 900 m²/g or less, more preferably 700 m²/g or less, and even more preferably 500 m²/g or less. With respect to amorphous oxides other than porous materials such as the silica gel, rather than the average specific surface area, the average particle size is preferably set to within a preferable range.

When the average specific surface area is equal to or less than the upper limit of the above range, an increase in the hygroscopicity of the gas-generating agent composition can be more easily prevented. In addition, when the average specific surface area is equal to or greater than the lower limit of the above-described range, a decrease in combustibility is more easily prevented.

The average specific surface area described above can be measured by a gas adsorption method.

### Additional Components

The gas-generating agent composition may contain components (hereinafter, referred to as “additional components”) other than the above-described guanidine nitrate, basic copper nitrate, potassium perchlorate, and amorphous oxide, and examples of the additional components include fuel components other than guanidine nitrate; oxidants other than basic copper nitrate and potassium perchlorate; binders; lubricants; neutralizing agents; and other known additives.

Examples of the fuel component other than guanidine nitrate include one or more selected from tetrazole compounds including 5-aminotetrazole and bitetrazole ammonium salt; guanidine compounds (excluding nitroguanidine) including guanidine nitrate and dicyandiamide; and triazine compounds including melamine, trimethylolmelamine, alkylated methylolmelamine, ammeline, ammelide, nitrates of melamine, perchlorates of melamine, trihydrazinotriazine, and nitrated compounds of melamine. Moreover, of the above components (A), a component other than these fuel components may also be used as a fuel component.

Examples of the oxidant other than basic copper nitrate and potassium perchlorate include one or more selected from basic cobalt nitrate, basic zinc nitrate, basic manganese nitrate, metal nitrates, ammonium nitrate, metal perchlorates, ammonium perchlorate, metal chlorates, and metal nitrites. Moreover, of the above components (B), a component other than these oxidants may be used as an oxidant.

Examples of the binder include one or more selected from carboxymethyl cellulose (CMC), carboxymethyl cellulose sodium salt (CMCNa), carboxymethyl cellulose potassium salt, carboxymethyl cellulose ammonium salt, cellulose acetate, cellulose acetate butyrate (CAB), ethyl cellulose (EC), hydroxyethyl cellulose (HEC), microcrystalline cellulose, polyacryl hydrazide, acrylamide-acrylic acid metal salt copolymers, polyacrylamide-polyacrylate compound copolymers, acrylic rubber and silicone. Moreover, of the abovementioned components (C), a component other than these binders may also be used as a binder. The gas-generating composition may or may not contain a binder.

Examples of the lubricant include one or more selected from calcium stearate, magnesium stearate, and the like.

Examples of the neutralizing agent include compounds containing one or more cations selected from alkali metals and alkaline earth metals. Such compounds include carbonates, silicates, nitrates, oxalates, peroxides or oxides of alkali metals and alkaline earth metals, such as, for example, sodium carbonate, sodium silicate, sodium nitrate, sodium oxalate, strontium peroxide, calcium peroxide, magnesium oxide, strontium oxide or calcium oxide.

Examples of other known additives include one or more selected from metal oxides such as copper(II) oxide, iron oxide, zinc oxide, cobalt oxide, manganese oxide, molybdenum oxide, nickel oxide, bismuth oxide, silica, and alumina; metal hydroxides such as aluminum hydroxide, magnesium hydroxide, cobalt hydroxide, and iron hydroxide; cobalt carbonate, calcium carbonate; composite compounds of metal oxides or hydroxides, such as acidic clay, kaolin, talc, bentonite, and diatomaceous earth; metallic acid salts such as sodium silicate, mica molybdate, cobalt molybdate, and ammonium molybdate; and molybdenum disulfide, calcium stearate, silicon nitride, silicon carbide, metaboric acid, boric acid, and boric anhydride, and glass.

The gas-generating agent composition may contain, as an additional component, Al(OH)₃ (aluminum hydroxide) in addition to the above-mentioned components, and from the viewpoint of reducing the combustion temperature of the gas-generating agent composition, this additive is advantageous when aminophosphate glass is used as the amorphous oxide.

When Al(OH)₃ is used, the content of the Al(OH)₃ in the gas-generating agent composition is not particularly limited, but from the viewpoint of reducing the combustion temperature of the gas-generating agent composition, the content thereof is preferably from 0.5 wt. % to 10 wt. %, more preferably from 1 wt. % to 10 wt. %, and even more preferably from 1 wt. % to 8 wt. %.

The content of each component in the gas-generating agent composition can be analyzed by a general qualitative analysis method and a general quantitative analysis method. For example, the content can be analyzed by combining results of measurements such as ion chromatography, FT-IR, ICP-AES, and XRD. The content of each component can also be calculated from the amounts of raw materials used in the gas-generating agent composition.

The gas-generating agent composition can be molded into a desired shape for use, and can be formed into a molded article (gas-generating agent molded article) having a shape such as a pellet shape, a disk shape, a spherical shape, a rod shape, a cylindrical shape, a single-hole cylindrical shape, or a multi-hole cylindrical shape, and in particular, a pellet shape, a single-hole cylindrical shape, or a multi-hole cylindrical shape is preferable. These molded articles can be produced by a method of adding water or an organic solvent to the gas-generating agent composition, mixing, and then subjecting the mixture to extrusion molding, or by a method of subjecting the mixture to compression molding using a tableting machine or the like.

Because the gas-generating agent composition according to an embodiment of the present disclosure has a high combustion rate, the molded article does not need to be made small, and a complicated production process is not required.

The gas-generating agent composition according to an embodiment of the present disclosure or a molded article therefrom (hereinafter, may be referred to as, in various vehicles, the gas-generating agent composition or the like) can be applied to, for example, an airbag inflator for a driver's seat, an airbag inflator for a front passenger seat, a side airbag inflator, an inflator for an inflatable curtain, an inflator for a knee bolster, an inflator for an inflatable seat belt, an inflator for a tubular system, or an inflator for a pretensioner. Among these, the gas-generating agent composition or the like can be preferably applied to a side airbag inflator that requires early deployment and particularly requires a short ignition time and a sufficient combustion amount.

An inflator containing the gas-generating agent composition or a molded article therefrom may be a pyro-type in which the supply source of gas is only the gas-generating agent or may be a hybrid-type in which a gas is supplied from both compressed gas, such as argon, and the gas-generating agent.

The gas-generating agent composition or a molded article therefrom can also be used as an igniting agent called an enhancer (or a booster), which serves to transmit an energy of a detonator or a squib to the gas-generating agent.

### Method for Producing Gas-Generating Agent Composition

The method for producing the above-described gas-generating agent composition is not particularly limited, and the gas-generating agent composition can be produced by a known method or by a combination of known methods. For example, the composition can be produced by preparing and mixing desired raw materials. Specifically, the gas-generating agent composition can be produced by a dry method in which raw materials are mixed in a powdery state, or by a wet method in which raw materials are mixed in the presence of water, an organic solvent, or the like.

When the gas-generating agent composition is used as a molded article, the molded article can be produced by using a tableting machine to compression mold the mixture produced by the above dry method, or the molded article can be produced by extruding with an extruder the mixture produced by the above wet method, followed by cutting and drying. The production conditions in these methods for producing the molded article are not particularly limited and can be appropriately set according to the purpose. For example, when the extrusion molding method is applied, molding an article with a thin web is easier than the compression molding method, and therefore a molded article can be produced even with a composition having a slow combustion rate. Furthermore, the extrusion molding method is suitable for mass production because molding is carried out in a relatively short time. In addition, when the extrusion molding method is applied, a molded article having a complex shape such as a non-hole shape, a single-hole shape, or a multi-hole shape can be produced, and thus various combustion characteristics can be imparted.

In the production of the gas-generating agent composition, when molding is carried out using the above-mentioned tableting machine, a lubricating agent (lubricant) is preferably used. The type of the lubricating agent is not particularly limited, and examples thereof include calcium stearate, magnesium stearate, sucrose fatty acid esters, and talc. The content of the lubricating agent in the gas-generating agent composition may be from 0.1 mass % to 1 mass %, or from 0.15 mass % to 0.6 mass %.

In the measurement of each characteristic in the present disclosure, unless otherwise specified, before the measurement, the measurement sample is held for 2 hours or more in an environment that is the same as the environment in which the measurement will be carried out. Moreover, unless otherwise specified, the measurement temperature, measurement humidity, and measurement pressure are set to the normal temperature (26±2 °C), normal humidity (59±5% RH), and normal pressure (atmospheric pressure).

### EXAMPLES

Hereinafter, the present disclosure will be further specifically described by showing examples. However, the present disclosure is not to be interpreted as being limited to the examples below.

### Test 1

### Production of Gas-Generating Agent Composition

### Comparative Example 1

Raw materials were prepared at the proportions shown in Table 2, and these raw materials were then mixed with water having a weight of 0.16 times the total weight of the raw materials, after which the mixture was extruded by an extrusion molding machine at a shear rate of from 200/sec to 1000/sec using a 3.4 mm mold, and the diameter of the resulting sample when shrunk after drying was 3.2 mm. The sample produced through this extrusion was cut to lengths of from 2.6 to 2.9 mm to form cylindrical pellets. To remove the water, the pellets were allowed to stand at normal temperature for 48 hours or more as a pre-drying and then dried in a dryer at 110 °C for 72 hours or more, and thereby a gas-generating agent composition (oxygen balance: −0.01 g/g) was produced. This oxygen balance is the oxygen balance calculated on the basis of the above-described components (A) to (D), and the same applies to other examples and comparative examples.

### Comparative Example 2

Raw materials were prepared at the proportions shown in Table 2, and these raw materials were then mixed with water having a weight of 0.16 times the total weight of the raw materials, after which a gas-generating agent composition (oxygen balance: −0.01 g/g) was produced in the same manner as in Comparative Example 1.

### Comparative Example 3

Raw materials were prepared at the proportions shown in Table 2 and these raw materials were mixed, and then the mixture was granulated. Subsequently, 0.15 wt. % of calcium stearate in relation to the total weight of the raw materials was added as a lubricating agent (lubricant), after which a tableting machine was used to compression mold the mixture at a condition of 19 to 22 kN, and thereby a gas-generating agent composition (oxygen balance: −0.01 g/g) was produced in the form of cylindrical pellets having a bottom surface diameter of 3.2 mm and a height of from 2.6 to 2.9 mm.

### Comparative Example 4

Raw materials were prepared at the proportions shown in Table 2, and these raw materials were then mixed with water having a weight of 0.16 times the total weight of the raw materials, after which a gas-generating agent composition (oxygen balance: −0.01 g/g) was produced in the same manner as in Comparative Example 1.

### Comparative Example 5

Raw materials were prepared at the proportions shown in Table 2, and these raw materials were then mixed with water having a weight of 0.16 times the total weight of the raw materials, after which a gas-generating agent composition (oxygen balance: −0.01 g/g) was produced in the same manner as in Comparative Example 1.

### Comparative Example 6

Raw materials were prepared at the proportions shown in Table 2, and these raw materials were then mixed with water having a weight of 0.16 times the total weight of the raw materials, after which a gas-generating agent composition (oxygen balance: −0.01 g/g) was produced in the same manner as in Comparative Example 1.

### Example 1

Raw materials were prepared at the proportions shown in Table 2 and these raw materials were mixed, after which a gas-generating agent composition (oxygen balance: −0.01 g/g) was produced in the same manner as in Comparative Example 3. As the aluminoborosilicate glass, one having an average particle size of 11 μm and an average length of 75 μm (average aspect ratio: 6.82) was used.

### Example 2

Raw materials were prepared at the proportions shown in Table 2, and these raw materials were then mixed with water having a weight of 0.16 times the total weight of the raw materials, after which a gas-generating agent composition (oxygen balance: −0.01 g/g) was produced in the same manner as in Comparative Example 1. As the silica gel, one having an average particle size of from 3 to 5 μm, an average aspect ratio of from 1 to 1.2, and an average specific surface area of 300 m²/g was used.

### Example 3

Raw materials were prepared at the proportions shown in Table 2, and these raw materials were then mixed with water having a weight of 0.16 times the total weight of the raw materials, after which a gas-generating agent composition (oxygen balance: −0.01 g/g) was produced in the same manner as in Comparative Example 1. As the aluminoborosilicate glass, one having an average particle size of 11 μm, an average length of 75 μm, and an average aspect ratio of 6.82 was used.

### Combustion Test Under Atmospheric Pressure

100 g of the gas-generating agent composition was placed on a plate made of SUS, and at a test site under atmospheric pressure, a nichrome wire was brought into contact with a portion thereof, a predetermined current was passed through the nichrome wire, the gas-generating agent composition was ignited by the fusion energy thereof, and the 100 g of the gas-generating agent composition was combusted. Then, it was confirmed whether some non-combusted gas-generating agent composition remained (combustion was interrupted) or all of the gas-generating agent composition was completely combusted. The confirmation results are presented in Table 2. In Table 2, A means complete combustion was achieved, and B indicates that combustion was interrupted.

The meanings of the abbreviations in Table 2 are indicated below. The same applies to other tables.
GN: guanidine nitrate;
BCN: basic copper nitrate
KClO₄: potassium perchlorate
Al(OH)₃: aluminum hydroxide
CMCNa: carboxymethyl cellulose sodium salt

Note that the blending proportions in Table 2 can be regarded as the content proportions of components in the gas-generating agent composition.

### 5-cc Bomb 10% Ignition Time

A predetermined amount of 0.7 g of the above-mentioned gas-generating agent composition was inserted into a 5-cc bomb test jig and ignited in a low-temperature environment (−40 °C) by a priming powder containing ZPP, and the time to reach 10% of the maximum pressure was defined as the ignition time.

TABLE 2

| | | Blending proportion | | | | | | | |
|---|---|---|---|---|---|---|---|---|---|
| | | | | | | | Aluminoboro- | Alumino- | |
| | | | | | | | silicate | phosphate | Silicon |
| | Production | GN | BCN | KClO₄ | Al(OH)₃ | CMCNa | glass | glass | dioxide |
| | process | wt. % | wt. % | wt. % | wt. % | wt. % | wt. % | wt. % | wt. % |
| Comparative | Wet | 43.00 | 52.00 | 0.00 | 0.00 | 5.00 | 0.00 | 0.00 | 0.00 |
| Example 1 | method | | | | | | | | |
| Comparative | Wet | 50.60 | 37.45 | 8.95 | 0.00 | 3.00 | 0.00 | 0.00 | 0.00 |
| Example 2 | method | | | | | | | | |
| Comparative | Dry | 58.44 | 29.56 | 12.00 | 0.00 | 0.00 | 0.00 | 0.00 | 0.00 |
| Example 3 | method | | | | | | | | |
| Comparative | Wet | 46.84 | 36.16 | 12.00 | 0.00 | 5.00 | 0.00 | 0.00 | 0.00 |
| Example 4 | method | | | | | | | | |
| Comparative | Wet | 46.31 | 35.69 | 12.00 | 1.00 | 5.00 | 0.00 | 0.00 | 0.00 |
| Example 5 | method | | | | | | | | |
| Comparative | Wet | 45.24 | 34.76 | 12.00 | 3.00 | 5.00 | 0.00 | 0.00 | 0.00 |
| Example 6 | method | | | | | | | | |
| Example 1 | Dry | 57.38 | 28.62 | 12.00 | 0.00 | 0.00 | 2.00 | 0.00 | 0.00 |
| | method | | | | | | | | |
| Example 2 | Wet | 46.31 | 35.69 | 12.00 | 0.00 | 5.00 | 0.00 | 0.00 | 1.00 |
| | method | | | | | | | | |
| Example 3 | Wet | 46.18 | 33.42 | 13.40 | 0.00 | 5.00 | 2.00 | 0.00 | 0.00 |
| | method | | | | | | | | |

| | | Blending proportion | | | | |
|---|---|---|---|---|---|---|
| | | with GN + BCN + | | | | |
| | | KClO₄ being 100 | | | | 5-cc Bomb |
| | | parts by weight | | | | 10% ignition |
| | | GN | BCN | KClO₄ | | time (when |
| | | Parts | Parts | Parts | Combustion | adjusted |
| | Production | by | by | by | amount | to −40 °C) |
| | process | weight | weight | weight | — | milliseconds |
| Comparative | Wet | 45.26 | 54.74 | 0.00 | A | 7.6 |
| Example 1 | method | | | | | |
| Comparative | Wet | 52.16 | 38.61 | 9.23 | A | 4.5 |
| Example 2 | method | | | | | |
| Comparative | Dry | 58.44 | 29.56 | 12.00 | B | 3.6 |
| Example 3 | method | | | | | |
| Comparative | Wet | 49.31 | 38.06 | 12.63 | B | 3.9 |
| Example 4 | method | | | | | |
| Comparative | Wet | 49.27 | 37.97 | 12.77 | B | 3.9 |
| Example 5 | method | | | | | |
| Comparative | Wet | 49.17 | 37.78 | 13.04 | B | 4.2 |
| Example 6 | method | | | | | |
| Example 1 | Dry | 58.55 | 29.20 | 12.24 | A | 3.5 |
| | method | | | | | |
| Example 2 | Wet | 49.27 | 37.97 | 12.77 | A | 4.0 |
| | method | | | | | |
| Example 3 | Wet | 49.66 | 35.94 | 14.41 | A | 4.0 |
| | method | | | | | |

Table 2 shows that the ignition time becomes shorter as the blending proportion of potassium perchlorate in the gas-generating agent composition increases. On the other hand, in the embodiments in which no amorphous oxide was added, combustion was interrupted when the blending amount of potassium perchlorate was 11 wt. % or greater, whereas in the embodiments in which an amorphous oxide was added, complete combustion was achieved while maintaining a short ignition time, even when the blending amount of potassium perchlorate was 11 wt. % or greater.

### Comparative Example 7

Raw materials were prepared at the proportions shown in Table 3, and these raw materials were then mixed with water of a weight of 0.16 times the total weight of the raw materials, after which a gas-generating agent composition (oxygen balance: −0.01 g/g) was produced in the same manner as in Comparative Example 1.

### Comparative Example 8

Raw materials were prepared at the proportions shown in Table 3, and these raw materials were then mixed with water of a weight of 0.16 times the total weight of the raw materials, after which a gas-generating agent composition (oxygen balance: −0.01 g/g) was produced in the same manner as in Comparative Example 1.

### Comparative Example 9

Raw materials were prepared and mixed at the proportions shown in Table 3, after which a gas-generating agent composition (oxygen balance: −0.01 g/g) was produced in the same manner as in Comparative Example 3.

### Example 4

Raw materials were prepared and mixed at the proportions shown in Table 3, after which a gas-generating agent composition (oxygen balance: −0.01 g/g) was produced in the same manner as in Comparative Example 3. As the aluminophosphate glass, one having an average particle size of from 30 to 65 μm and an average aspect ratio of from 1 to 2 was used.

The properties of each of the abovementioned gas-generating agent compositions were evaluated by the same tests as the abovementioned combustion test under atmospheric pressure and evaluation test of the 5-cc bomb 10% ignition time using 100 g of the gas-generating agent composition. The evaluation results are presented in Table 3.

TABLE 3

| | | Blending proportion | | | | | | | |
|---|---|---|---|---|---|---|---|---|---|
| | | | | | | | Aluminoboro- | Alumino- | |
| | | | | | | | silicate | phosphate | Silicon |
| | Production | GN | BCN | KClO₄ | Al(OH)₃ | CMCNa | glass | glass | dioxide |
| | process | wt. % | wt. % | wt. % | wt. % | wt. % | wt. % | wt. % | wt. % |
| Comparative | Wet | 45.34 | 42.86 | 6.80 | 0.00 | 5.00 | 0.00 | 0.00 | 0.00 |
| Example 7 | method | | | | | | | | |
| Comparative | Wet | 40.71 | 49.29 | 0.00 | 5.00 | 5.00 | 0.00 | 0.00 | 0.00 |
| Example 8 | method | | | | | | | | |
| Comparative | Dry | 56.35 | 24.65 | 14.00 | 5.00 | 0.00 | 0.00 | 0.00 | 0.00 |
| Example 9 | method | | | | | | | | |
| Example 4 | Dry | 56.35 | 24.65 | 14.00 | 4.00 | 0.00 | 0.00 | 1.00 | 0.00 |
| | method | | | | | | | | |

| | | Blending proportion | | | | |
|---|---|---|---|---|---|---|
| | | with GN + BCN + | | | | |
| | | KClO₄ being 100 | | | | 5-cc Bomb |
| | | parts by weight | | | | 10% ignition |
| | | GN | BCN | KClO₄ | | time (when |
| | | Parts | Parts | Parts | Combustion | adjusted |
| | Production | by | by | by | amount | to −40 °C) |
| | process | weight | weight | weight | — | milliseconds |
| Comparative | Wet | 47.73 | 45.12 | 7.16 | A | 6.7 |
| Example 7 | method | | | | | |
| Comparative | Wet | 45.23 | 54.77 | 0.00 | A | 10.4 |
| Example 8 | method | | | | | |
| Comparative | Dry | 59.32 | 25.95 | 14.74 | B | 3.8 |
| Example 9 | method | | | | | |
| Example 4 | Dry | 59.32 | 25.95 | 14.74 | A | 4.2 |
| | method | | | | | |

Table 3 shows that the ignition time becomes shorter as the blending proportion of potassium perchlorate in the gas-generating agent composition increases. On the other hand, in the embodiments in which no amorphous oxide was added, combustion was interrupted when the blending amount of potassium perchlorate was 11 wt. % or greater, whereas in the embodiment in which an amorphous oxide was added, complete combustion was achieved while maintaining a short ignition time, even when the blending amount of potassium perchlorate was 11 wt. % or greater.

### Test 2

### Production of Gas-Generating Agent Composition

### Reference Example 1

Raw materials were prepared at the proportions shown in Table 4 and these raw materials were mixed, after which a gas-generating agent composition was produced in the same manner as in Comparative Example 3.

### Reference Example 2

Raw materials were prepared at the proportions shown in Table 4 and these raw materials were mixed, after which a gas-generating agent composition was produced in the same manner as in Comparative Example 3.

### Reference Example 3

Raw materials were prepared at the proportions shown in Table 4 and these raw materials were mixed, after which a gas-generating agent composition was produced in the same manner as in Comparative Example 3.

### Reference Example 4

Raw materials were prepared at the proportions shown in Table 4 and these raw materials were mixed, after which a gas-generating agent composition was produced in the same manner as in Comparative Example 3.

### Load-Bearing Strength Test

One pellet of the gas-generating agent was sandwiched between flat metal jigs and diametrically compressed, a load was applied using a compression tester, and the point at which the pellet cracked and fractured was measured as the load-bearing strength. The evaluation results thereof are shown in Table 4.

TABLE 4

| | | | | | | | | | | Blending proportion | | |
|---|---|---|---|---|---|---|---|---|---|---|---|---|
| | | | | | | | | | | with GN + BCN being | | |
| | | Blending proportion | | | | | | | | 100 parts by weight | | |
| | | | | | | | Aluminoboro- | Alumino- | | GN | BCN | Load- |
| | | | | | | | silicate | phosphate | Silicon | Parts | Parts | bearing |
| | Production | GN | BCN | KClO₄ | Al(OH)₃ | CMCNa | glass | glass | dioxide | by | by | strength |
| | process | wt. % | wt. % | wt. % | wt. % | wt. % | wt. % | wt. % | wt. % | weight | weight | Kgf |
| Reference | Dry | 30 | 70 | 0 | 0 | 0 | 0 | 0 | 0 | 30 | 70 | 14.14 |
| Example 1 | method | | | | | | | | | | | |
| Referential | Dry | 50 | 50 | 0 | 0 | 0 | 0 | 0 | 0 | 50 | 50 | 16.71 |
| Example 2 | method | | | | | | | | | | | |
| Reference | Dry | 70 | 30 | 0 | 0 | 0 | 0 | 0 | 0 | 70 | 30 | 10.69 |
| Example 3 | method | | | | | | | | | | | |
| Reference | Dry | 100 | 0 | 0 | 0 | 0 | 0 | 0 | 0 | 100 | 0 | 3.06 |
| Example 4 | method | | | | | | | | | | | |

Table 4 shows that a gas-generating agent composition having excellent load-bearing strength can be produced by setting the amount of GN in the gas-generating agent composition to a specific range. In the system of the present embodiment containing GN and BCN as main components, the content proportion of GN is important with regard to the load-bearing strength, but the load-bearing strength is not easily affected by other substances such as BCN, KClO₄, and amorphous oxide. Therefore, it is considered that the same tendency would be exhibited even if substances such as KClO₄ and amorphous oxide are contained.

### INDUSTRIAL APPLICABILITY

The gas-generating agent composition according to the present disclosure has a short ignition time, and interruption of combustion in a low-pressure environment is less likely to occur. Therefore, the gas-generating agent composition can be completely combusted with a short ignition time even when the pressure inside the inflator becomes low, such as at the initial stage or the final stage of inflator operation. When the gas-generating agent composition is used in an airbag, a sufficient amount of gas for inflating the airbag can be secured, and the requirements necessary for restraining a passenger can be more easily satisfied.

1. A gas-generating agent composition comprising:
guanidine nitrate;
basic copper nitrate;
potassium perchlorate, a content of which is 12 parts by weight or more relative to 100 parts by weight of a total content of the guanidine nitrate, the basic copper nitrate, and the potassium perchlorate;
an amorphous oxide.

2. The gas-generating agent composition according to claim 1, wherein the amorphous oxide is one or more selected from the group consisting of silica gel, silicate glass, borosilicate glass, borate glass, aluminosilicate glass, aluminophosphate glass, and aluminoborosilicate glass.

3. The gas-generating agent composition according to claim 2, wherein the silica gel has an average specific surface area of 300 m²/g or greater.

4. The gas-generating agent composition according to claim 1, wherein a total content of the amorphous oxide in the gas-generating agent composition is from 0.1 wt. % to 10 wt. %.

5. The gas-generating agent composition according to claim 1, wherein the amorphous oxide has an average aspect ratio of 8 or less.

6. The gas-generating agent composition according to claim 1, wherein the amorphous oxide has an average particle size of from 1 μm to 100 μm.

7. The gas-generating agent composition according to claim 1, comprising no binder.

8. The gas-generating agent composition according to claim 7, wherein a content of the guanidine nitrate is from 30 mass % to 70 mass %.

9. The gas-generating agent composition according to claim 1, wherein an oxygen balance is from −0.05 g/g to 0.05 g/g, the oxygen balance being calculated on the basis of:
(A) guanidine nitrate, nitroguanidine, melamine, melamine cyanurate, 5-aminotetrazole, 5,5′-bitetrazole diammonium salt, guanylurea dinitramide, dicyanodicarbonamide, cyanuric acid, tartaric acid, Na tartrate, succinic acid, 3-nitro-1,2,4-triazol-5-one, 2-nitroimino-5-nitrohexahydro-1,3,5-triazine, and carbonaceous materials;
(B) basic copper nitrate, strontium nitrate, basic copper carbonate, 5-AT-BCN complex, copper oxide, potassium perchlorate, potassium chlorate, potassium nitrate, sodium nitrate, ammonium nitrate, ammonium perchlorate, sodium perchlorate, copper(II) oxide, copper(I) oxide, phase-stabilized ammonium nitrate (AN/KN=90/10), and phase-stabilized ammonium nitrate (AN/KN=85/15);
(C) sodium carboxymethyl cellulose, guar gum, polyacrylamide, hydroxyethyl cellulose, hydroxypropyl methyl cellulose, polyvinyl alcohol, ethyl cellulose, polyvinyl pyrrolidone, starch, and silicone; and
(D) calcium stearate and magnesium stearate.

10. The gas-generating agent composition according to claim 1, further comprising aluminum hydroxide.

11. A gas-generating agent molded article formed by molding the gas-generating agent composition described in claim 1 into a pellet shape, a single-hole cylindrical shape, or a multi-hole cylindrical shape.

12. A side airbag inflator comprising:
the gas-generating agent composition described in claim 1.

13. A side airbag inflator comprising:
the gas-generating agent molded article described in claim 1.
